(19) United States
(12) Patent Application Publication
(10) Pub. No.: US 2024/0224164 A1
(43) Pub. Date: Jul. 4, 2024

(54) DEVICE MANAGEMENT

(71) Applicant: Nokia Solutions and Networks Oy, Espoo, FL (US)

(72) Inventors: Colin GREALISH, Brighton (GB); Bahadir DANISIK, Austin, TX (US)

(21) Appl. No.: 18/554,123

(22) PCT Filed: Mar. 28, 2022
(86) PCT No.: PCT/US2022/022130

§ 371 Date: Oct. 5, 2023

(30) Foreign Application Priority Data
Apr. 22, 2021 (GB) 2105725.2

(51) Int. Cl. H04W 48/12; H04W 4/50; H04W 24/02; H04W 64/00

(52) U.S. Cl. CPC H04W 48/12; H04W 4/50; H04W 24/02; H04W 64/003

(57) ABSTRACT

According to an example aspect of the present invention, there is provided an apparatus configured to define a set of devices for a device management action, store a location of each one of the devices, each location being defined in terms of network hierarchy, each location comprising a network identifier of the device in at least three levels of the network hierarchy, and perform the device management action on each device in the set in an order selected based on the location such that consecutive ones of the devices in the order are separated at as high a level of the network hierarchy as possible. The devices may comprise Internet of Things devices or 5G user equipments, for example.

### FIELD

The present disclosure relates to management of devices via communication networks.

### BACKGROUND

Management of devices such as, for example, Internet of Things, IoT, devices presents with challenges. IoT devices, or other managed devices, may be predominantly designed for low-bandwidth operation while management of these devices may require fairly large amounts of data to be transferred, especially for large numbers of such managed devices.

Examples of managed devices include utility meters, such as water or electricity meters, connected units of cars, surveillance devices and smoke or carbon monoxide detectors. Managed devices may be wireless managed devices, they may communicate using a wireless communication.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core, at least one memory including computer program code, the at least one memory and the computer program code being configured to, with the at least one processing core, cause the apparatus at least to define a set of devices for a device management action, store a location of each one of the devices, each location being defined in terms of network hierarchy, each location comprising a network identifier of the device in at least three levels of the network hierarchy, and perform the device management action on each device in the set in an order selected based on the location such that consecutive ones of the devices in the order are separated at as high a level of the network hierarchy as possible.

According to a second aspect of the present disclosure, there is provided a method comprising defining, in an apparatus, a set of devices for a device management action, storing a location of each one of the devices, each location being defined in terms of network hierarchy, each location comprising a network identifier of the device in at least three levels of the network hierarchy, and performing the device management action on each device in the set in an order selected based on the location such that consecutive ones of the devices in the order are separated at as high a level of the network hierarchy as possible.

According to a third aspect of the present disclosure, there is provided an apparatus comprising means for defining, in an apparatus, a set of devices for a device management action, means for storing a location of each one of the devices, each location being defined in terms of network hierarchy, each location comprising a network identifier of the device in at least three levels of the network hierarchy, and means for performing the device management action on each device in the set in an order selected based on the location such that consecutive ones of the devices in the order are separated at as high a level of the network hierarchy as possible.

According to a fourth aspect of the present disclosure, there is provided a non-transitory computer readable medium having stored thereon a set of computer readable instructions that, when executed by at least one processor, cause an apparatus to at least define a set of devices for a device management action, store a location of each one of the devices, each location being defined in terms of network hierarchy, each location comprising a network identifier of the device in at least three levels of the network hierarchy, and perform the device management action on each device in the set in an order selected based on the location such that consecutive ones of the devices in the order are separated at as high a level of the network hierarchy as possible.

According to a fifth aspect of the present disclosure, there is provided a computer program configured to cause at least the following to be performed, when run by a computer: defining, in an apparatus, a set of devices for a device management action, storing a location of each one of the devices, each location being defined in terms of network hierarchy, each location comprising a network identifier of the device in at least three levels of the network hierarchy, and performing the device management action on each device in the set in an order selected based on the location such that consecutive ones of the devices in the order are separated at as high a level of the network hierarchy as possible.

According to a sixth aspect of the present disclosure, there is provided a system comprising an apparatus according to the first aspect and an internet of things, IoT, device, wherein the IoT device is configured to transmit to the apparatus a request concerning whether the apparatus has a device management action pending for the IoT device, and responsive to the request the apparatus is configured to inform the IoT device concerning a device management action to be triggered for the IoT device.

### BRIEF DESCRIPTION OF THE DRAWINGS

FIG. 1 illustrates an example system in accordance with at least some embodiments of the present invention;

FIG. 2 illustrates an example network hierarchy;

FIG. 3 illustrates an example apparatus capable of supporting at least some embodiments of the present invention;

FIG. 4 illustrates a method in accordance with at least some embodiments of the present invention, and

FIG. 5 is a flow graph of a method in accordance with at least some embodiments of the present invention.

### EMBODIMENTS

As will be disclosed herein, device management of a number of devices, for example hundreds or thousands of devices, may be performed in an optimized manner by spreading out the device management actions in terms of network hierarchy, that is the logical network topology, to avoid overloading network resources, such as a control plane, a data plane or communication resources of the network. For example, resources of a core network or access network may be protected from overloading. In effect, consecutive ones of devices to be managed are ordered to maximize a distance between them in terms of logical network topology by selecting a next device such that it differs at a highest possible network hierarchy level from the immediately preceding device intended for the device management action. The network hierarchy may be a hierarchy of a cellular communication network, for example.

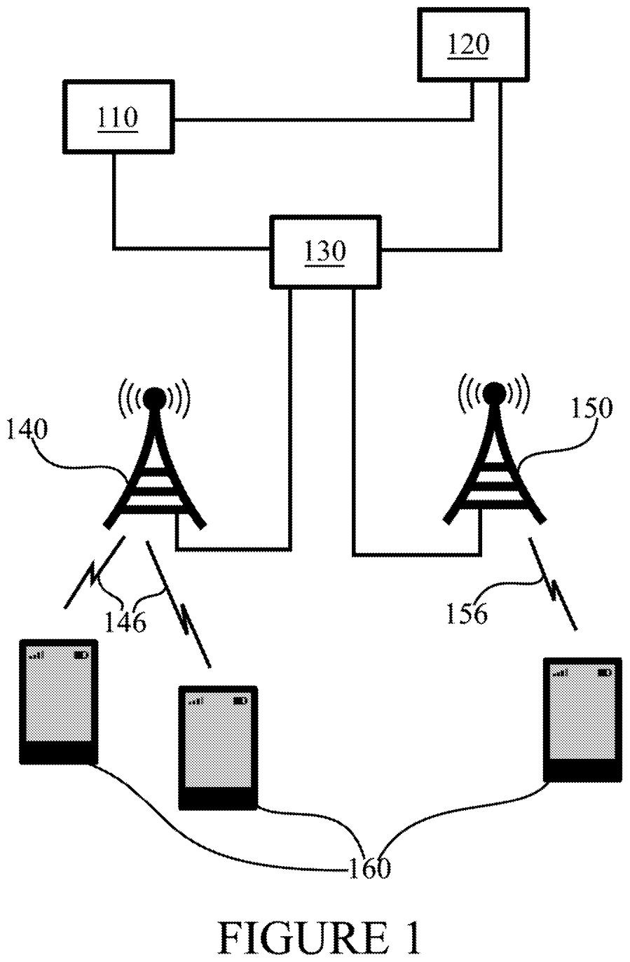

FIG. 1 illustrates an example system in accordance with at least some embodiments of the present invention. The system of FIG. 1 comprises a device management server 110, which will be referred to herein as DMS 110 for the sake of brevity. DMS 110 may be a stand-alone server device, or it may be implemented as a software functionality in a physical computing substrate which is also configured to perform other functions, such as network management functions or subscriber repository functions, for example. DMS 110 may be comprised in a core network, for example, or in a network external to the communication system.

DMS 110 is configured to communicate with core network node 130, which may comprise a mobility management entity, MME, or a core network node with another name, depending on the networking technology used. Core network node 130 is configured to control plural base stations 140, 150 either directly or via a separate radio access network controller. A radio access network controller is not illustrated in FIG. 1 for the sake of clarity of the illustration. Naturally, there may be plural core network nodes 130 and in a realistic situation, the number of base stations is far larger than two. In fact, there may by plural core networks, in case plural public land mobile networks, PLMNs, are used. In other words, DMS 110 may be configured to communicate with plural public networks, such as PLMNs.

Devices 160 are communicatively coupled with base stations 140, 150 via respective radio links 146, 156, as illustrated. Devices 160 may comprise IoT devices or other power-constrained devices. In some embodiments devices 160 are user equipments, however in other embodiments they are not user equipments, but machine-type communication nodes, for example. Devices 160 may further be constrained regarding processing and/or memory capability, as they need not be over-designed with regard to their tasks. Devices 160 nonetheless are likely to need device management actions, such as updates to firmware, updates to a configuration file or calibration information, encryption key updates, update of an image file that the devices 160 are to display, reading parameters from devices 160, executing commands in devices 160 or operating parameter updates, for example. Such device management actions may take place relatively seldom, for example once every few years.

Such device management actions present some challenges, namely in case of a large number of devices 160, simultaneously communicating with them may cause a peak in network load. To optimize the device management bulk, or batch, actions, geographic location information of devices 160 may be unreliable in case devices 160 are not furnished with satellite positioning receivers, or are placed in locations, such as basements, where signals from satellite positioning constellations cannot be dependably received. Even where location information in devices 160 would be reliable, retrieving it from a large number of devices 160 would in itself cause a peak in network load. Further, power-constrained devices, such as power-constrained IoT devices, have limited communication capability wherefore they are inherently vulnerably to being overloaded as to communication capability. To save resources in terms of power and network interference, some power-constrained devices are configured to use a control channel to transfer also data, since this obviates the need for a separate data channel. This increases the vulnerability of these devices to increases in momentary communication requirements. On the other hand, performing a batch device management action to as many devices as possible simultaneously is useful as it reduces the time it takes to perform the batch device management operation the entire fleet of devices 160 that is to be managed.

To at least in part overcome these challenges, DMS 110 is configured to define a set of devices 160 for a device management action and to access and/or store locations of each of these devices 160. The set may be defined in terms of it being uploaded to DMS 110, or DMS 110 creating it from a database it has access to, for example. DMS 110 may alternatively or additionally subscribe to location information of devices 160, in which case updates to this location information may be pushed to DMS 110. DMS 110 may retrieve the locations from a network node such as, for example, a network exposure function, NEF, or the 4G alternative which is known as the Service Capability Exposure Function—SCEF, 120, for example. DMS 110 may retrieve the locations from NEF/SCEF by using a query message to obtain the locations of all devices matching a description provided in the query message, for example. In case DMS 110 already has the locations, it need not query them from another node. Alternative the NEF or SCEF can be set up to automatically report the location of the devices 160 when they change location. The choice to read location or be reported the location may be dependent on the level of traffic that is sustainable in the network 130. NEF/SCEF 120 may be, but need not be, connected with core network node 130 (or with another core network node).

The NEF or SCEF may thus be used by DMS 110 to provide the network location of each of devices 160 for use in the batch device management task in a way that ensures that the device management task is performed on each individual device 160 at a maximal distance, in terms of logical network topology, from other devices 160. NEF 120 is a term used in fifth generation, 5G, a corresponding functionality in fourth generation, 4G, systems is a service capability exposure function, SCEF. NEF/SCEF may provide a location of a device 160 in terms of network hierarchy down to the granularity of at least a cell identifier. A location expressed in terms of network hierarchy is a location which comprises a network identifier of the device in at least three levels of the network hierarchy, in other words, the location expressed in terms of network hierarchy may comprise at least three network identifiers of the device, the network identifiers being at different levels of the network hierarchy. For example, a location in the form of a network hierarchy may comprise a public-network identifier, a base station identifier and a cell identifier. The device would then be in a public land mobile network identified by the public-network identifier, in a cell identified by the cell identifier, this cell furthermore being controlled by a base station identified by the base station identifier. The interface between NEF 120 and DMS 110 may be called a N33 interface. The interface between the SCEF and Device Management server may be called a T8 interface.

In some embodiments, DMS 110 obtains the locations not by querying from NEF/SCEF but by querying from a different node, or from receiving the locations from a user configuration of the locations, for example.

To spread the batch device management action in an optimized manner among the plural devices 160 to receive the device management action, the DMS may perform the device management action on each device in the set in an order selected based on the location such that consecutive ones of the devices in the order are separated at as high a level of the network hierarchy as possible. In other words, DMS 110 may start with a first one of devices 160, trigger the device management action for this device, and then select the next device 160 for the device management action by finding out which one of the available devices 160 in the set differs from the first device 160 at a highest possible level of network hierarchy in the location. If possible, DMS 110 would choose a device 160 with a different public-network identifier at the most senior level of the network hierarchy. An example of a public-network identifier is a public land mobile network identifier, PLMN ID. In general, DMS 110 is configured to determine, from the set of devices 160 the device management action is to be performed on, an order in which the devices in the set are to receive the device management action and then to trigger the device management action for the devices in this order.

In some embodiments, the device management action is not necessarily a batch job but, rather, a situation where plural ones of devices 160 contact DMS 110 at more or less the same time, with requests and responses to these requests are spread out according to logical network topology, using the same order as described herein. In these cases, the set of devices 160 used to populate the order is the set of devices 160 which have sent requests to DMS 110. The requests need not be of the same type. In detail, the use of the order may be triggered as a response to at least a preconfigured number of requests arrive in DMS 110 within a preconfigured space of time. For example, if at least 200 requests arrive within ten seconds, or if at least 50 requests arrive within two seconds. Devices 160 may include in the request, information concerning at least one of the following: a fault in a sensor comprised in the IoT device and an out-of-range result in an output of a sensor comprised in the IoT device

In some embodiments, the location comprises a public-network identifier in the highest level of network hierarchy, an area identifier as a second-highest level of network hierarchy, a base station identifier as a third-highest level of network hierarchy and a cell identity as a fourth-highest level of network hierarchy. The area identifier may be routing area identifier or a tracking area identifier, for example, depending on the type of system. In some embodiments, there is further in the location a sector identifier as a fifth-highest level of network hierarchy.

In some embodiments, DMS 110 is configured to cause the device management action to be performed on at least two of devices 160 in the set simultaneously using broadcasting. This provides the benefit that more than one device may receive the device management action, such as firmware update, using only one instance of signalling. For example devices of a same type in a same cell may benefit from broadcasting the device management action. In other words, where at least two of devices 160 are in the same cell, DMS 110 may be configured to trigger the device management action to be delivered to these at least two devices 160 simultaneously, using broadcasting in this cell.

In some embodiments, DMS 110 is configured to cause a broadcasted message to be sent in a part of the network hierarchy to inform at least two of the devices in the set that the device management action will be performed. This part of the network hierarchy may be a single area, such as tracking area or routing area, for example, or a specific base station identified by a base station identifier. For example, a system information block may be modified with an indicator informing the devices 160 that they should set themselves in a state of readiness to receive the device management action. For example, devices 160 may respond to the indicator by refraining from originating data transmissions before the device management action is done. This provides the benefit, that a device 160 is not engaged in a routine task which occupies its communication capacity at a time, when DMS 110 triggers the start of the device management action for this device.

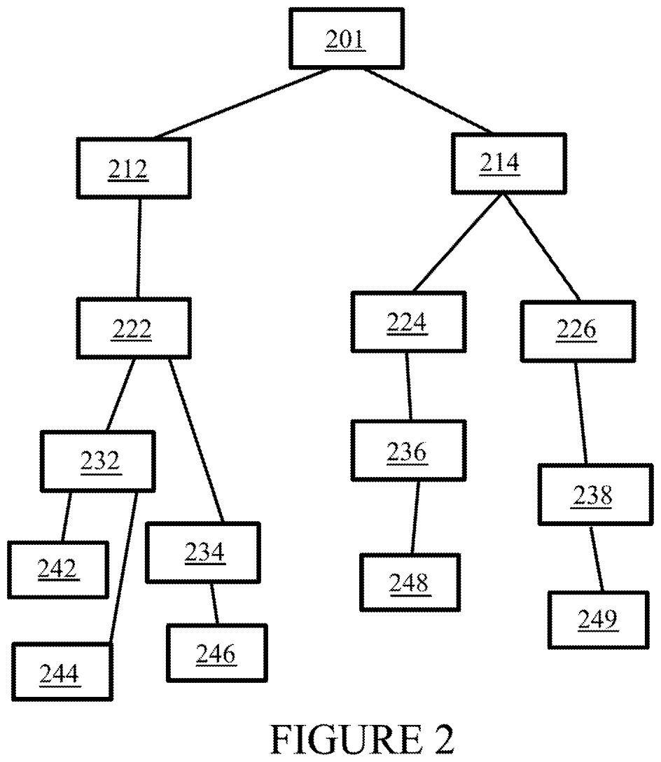

In detail, the order may be determined from the locations of the devices 160 in the set as follows. FIG. 2 illustrates an example network hierarchy.

The nominal top of the hierarchy is at root 201. At the highest level of the network hierarchy are PLMN identifiers 212 and 214. One level below the PLMN identifiers are area identifiers 222, 224 and 226, as illustrated. Areas 224 and 226 are under PLMN 214, with area 222 under PLMN 212, as denoted by the black lines in FIG. 2.

Below the area identifiers 222, 224 and 226 are base station identifiers 232, 234, 236 and 238, as illustrated, respectively, in the two PLMNs. Under the base station identifiers are the respective cell identifiers of cells controlled by these base stations, the cell identifiers being denoted in FIG. 2 as 242, 244, 246, 248 and 249.

As can be seen, the network hierarchy forms a tree structure. Only nodes with devices 160 under the node in the set are included in the tree. The order is determined by selecting one of the nodes in the lowest level of the network hierarchy, in FIG. 2 the initial node may be cell identifier 249, for example. A device 160 in this cell is selected as the first device 160 in the order. The first device may then be removed from the tree, set, or marked as used. The second device will be chosen by deviating from the immediately preceding one, the first one, at as high a level in the network hierarchy as possible. In terms of FIG. 2, this means selecting a device from PLMN 212, for example from cell 246. This is so, since there are devices 160 under a different PLMN than PLMN 214 and PLMN identifiers form the highest level of this network hierarchy.

For the third device, once more the DMS deviates from the immediately preceding device in the order, the second device, at as high a hierarchical level as possible. As there are devices in PLMN 214, this PLMN is selected. Further, the DMS deviates from the most recent device preceding but not immediately preceding the present device, in this case the first device, at as high a hierarchical level as possible. As the first device was selected from cell 249, which is under area 226, area 224 is selected and, in the example of FIG. 2, a device from cell 248 is the third device 160.

Likewise for the fourth device, in its selection a deviation at as high a level as possible is chosen from the immediately preceding device (the third device) as a first consideration, which means selecting PLMN 212. And likewise, for the fourth device a deviation at as high a level as possible is chosen for a preceding but not immediately preceding device (the second device) as a secondary consideration, wherefore base station 232 is chosen, and the fourth device is selected from one of cells 242 and 244. In particular, the device which is preceding but not immediately preceding may be the most recent device which precedes, but does not immediately precede, being the second-most recent device in the order.

In general, the order may be characterized as follows. As a primary consideration, a deviation at as high a hierarchical level as possible is selected from the device immediately preceding, in the order, the device which is to be placed in the order next. If, in the highest level of the hierarchy, it is possible to select a choice, such as PLMN, which has not yet been chosen for selecting a device into the order, this choice may be made. Subsequently when, in the highest level of the hierarchy, it is no longer possible to make a choice, such as PLMN, which hasn't yet been made for selecting a device into the order, then a choice, such as PLMN, is selected which has the oldest most recent device in the order. Thus in the highest level of the network hierarchy network regions are avoided which have recently been used to select devices into the order. As a secondary consideration, once a network identifier has been chosen for the next device to be placed in the order, a deviation is attempted at a hierarchical level immediately below that of the chosen network identifier with respect to a most recent device in the order with the chosen network identifier. This secondary consideration is repeated throughout the hierarchy until the lowest hierarchical level is reached, and the next device to be places in the order can be identified. In some embodiments, only the primary consideration is used and the secondary consideration is not employed.

Compiling the order in this manner, the device management action may triggered in the thus established order in a distributed manner among devices 160, and a technical benefit is obtained in that overloading of the control and/or data channels the devices use to communicate is avoided. This is so, since the device management action starts in distant parts of the network, topologically speaking, and the concurrent load is effectively spread in accordance with the capability of the network itself, which depends on the same logical topology as the order. In the event some devices 160 remain to be added to the order and they are in the same cell, they may be triggered to receive the device management action such that a delay is implemented after each such device, so as to not trigger the device management action to plural devices in the same cell at the same time. As an alternative to using a delay, or additionally to using a delay, a number of concurrent device management actions may be limited such that new device management actions are not started in case the limit is reached. New device management actions would in this case only be initiated once the number of concurrent actions drops below the limit. In general, the device management action may be triggered in the order without pausing before proceeding to the next device since triggering the device management action with respect to one device inherently takes a small time, staggering the management actions effectively.

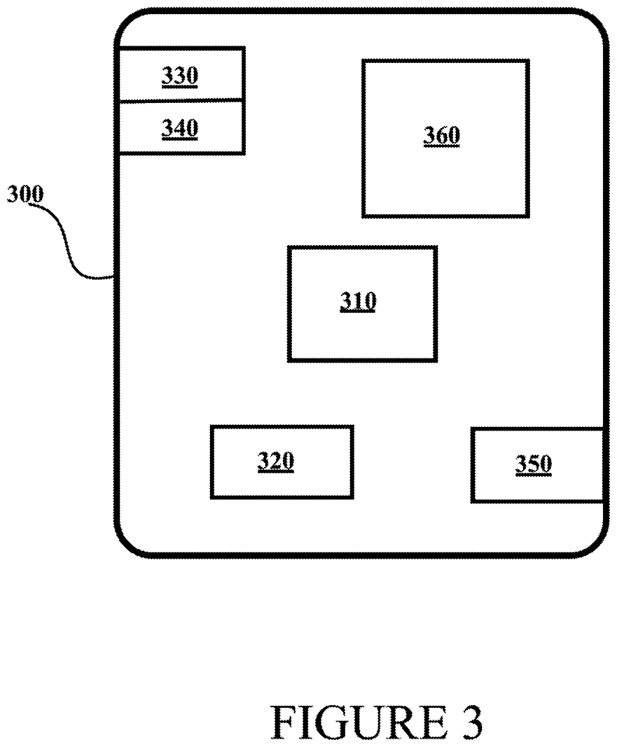

FIG. 3 illustrates an example apparatus capable of supporting at least some embodiments of the present invention. Illustrated is device 300, which may comprise, for example, DMS 110 of FIG. 1 or, in applicable parts, an IoT device 160. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Zen processing core designed by Advanced Micro Devices Corporation. Processor 310 may comprise at least one AMD Opteron and/or Intel Xeon processor. Processor 310 may comprise at least one application-specific integrated circuit, ASIC. Processor 310 may comprise at least one field-programmable gate array, FPGA. Processor 310 may be means for performing method steps in device 300, such as defining, storing, performing, causing and obtaining. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver.

Device 300 may comprise a near-field communication, NFC, transceiver 350. NFC transceiver 350 may support at least one NFC technology, such as NFC, Bluetooth, Wibree or similar technologies. NFC transceiver 350 may also be absent.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to configure device management actions, such as firmware updates.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, an IoT device may comprise one or more sensors such as electricity usage, water flow, gas flow sensor(s) and/or other fluid meters. Further examples of devices that may be comprised in an IoT device are location trackers, pollution sensors, thermostats, actuator(s) and at least one valve controller.

Processor 310, memory 320, transmitter 330, receiver 340, NFC transceiver 350 and/or UI 360 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

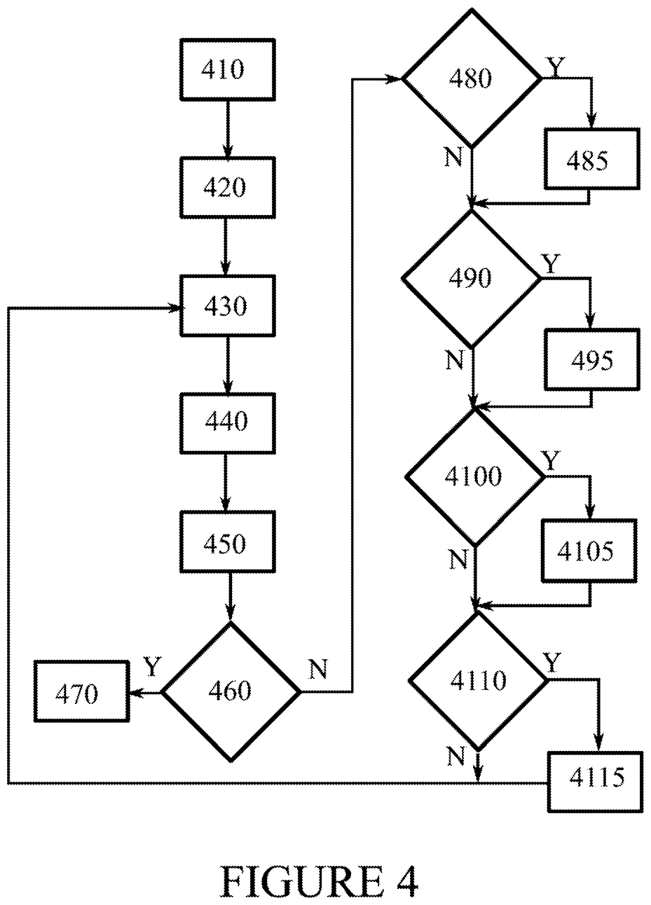

FIG. 4 illustrates a method in accordance with at least some embodiments of the present invention. Processing begins in DMS 110 at phase 410 and proceeds to phase 420, where a first device is selected from the set, for example the device with the numerically smallest (or numerically largest) PLMN identifier, area identifier, base station identifier and cell identifier may be selected as the first device. In phase 430, the first device is placed first in the order, and in phase 440 the PLMN identifier, the area identifier, the base station identifier and the cell identifier of the first device are recorded to support selection of further devices, as described herein above. In phase 450, the first device is removed from the set or the tree, or otherwise marked as allocated in the order.

In phase 460 it is determined if the all the devices 160 in the set have been allocated to the order. If this is the case, processing advances to 470 where it stops as the order is complete.

In case devices remain to be allocated to the order, processing advances to phase 480, where it is determined if there are further devices in the set, or tree, with PLMN identifiers that differ from the PLMN identifier of the device most recently placed in the order. If this is the case, Y, phase 485, the next device 160 to the order is selected from a different PLMN than the immediately preceding one. Otherwise, N, the next device in the order is chosen from the same PLMN,

In phase 490, is determined if there are further devices in the set, or tree, with area identifiers that differ from the area identifier of the device most recently placed in the order. If this is the case, Y, phase 495, the next device 160 to the order is selected from a different area than the immediately preceding one. Otherwise, N, the next device in the order is chosen from the same area. Of note, in case the PLMN is different, there will automatically be an area identifier different from that of the immediately preceding device in the order in this, different, PLMN. In this case, an area identifier will be selected which is different, whenever possible, from that of a most recent device placed in the order from this PLMN.

In phase 4100, is determined if there are further devices in the set, or tree, with base station identifiers that differ from the base station identifier of the device most recently placed in the order. If this is the case, Y, phase 4105, the next device 160 to the order is selected from a different base station than the immediately preceding one. Otherwise, N, the next device in the order is chosen from the same base station. Of note, in case the area is different, there will automatically be a base station identifier different from that of the immediately preceding device in the order in this, different, area. In this case, a base station identifier will be selected which is different, whenever possible, from that of a most recent device placed in the order from this area.

In phase 4110 is determined if there are further devices in the set, or tree, with cell identifiers that differ from the cell identifier of the device most recently placed in the order. If this is the case, Y, phase 4115, the next device 160 to the order is selected from a different cell than the immediately preceding one. Otherwise, N, the next device in the order is chosen from the same cell. Of note, in case the base station is different, there will automatically be a cell identifier different from that of the immediately preceding device in the order in this, different, base station. In this case, a cell identifier will be selected which is different, whenever possible, from that of a most recent device placed in the order from this base station.

Once the next device 160 to be placed in the order is selected from the set, or tree, processing returns to phase 430 where this device is placed in the order which is being constructed.

Acting in the discloses manner enables specific benefits, including the fact that DMS 110 need not query devices 160 for their location. Further, network load is spread out in the same shape as the logical network topology, yielding a synergistic effect since network capacity may also be seen as being spread out in the shape of the logical network topology.

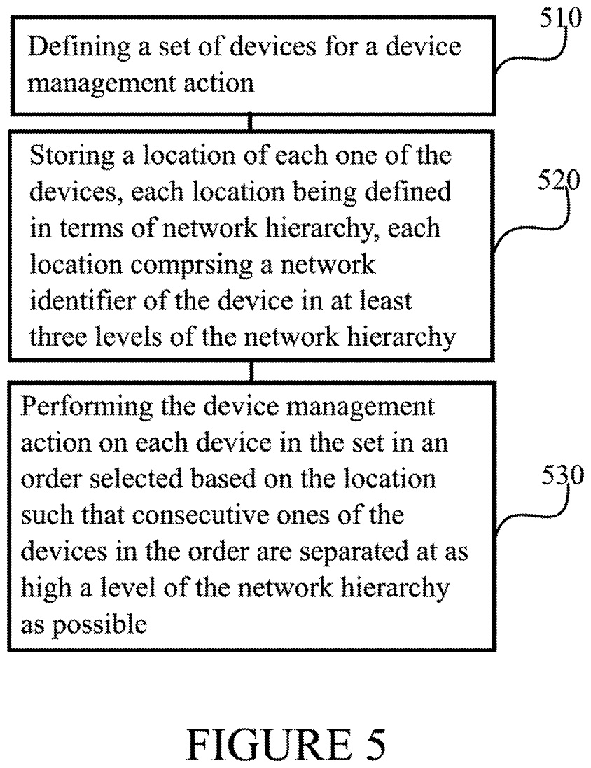

FIG. 5 is a flow graph of a method in accordance with at least some embodiments of the present invention. The phases of the illustrated method may be performed in DMS 110, an auxiliary device or a personal computer, for example, or in a control device configured to control the functioning thereof, when installed therein.

Phase 510 comprises defining, in an apparatus, a set of devices for a device management action. Phase 520 comprises storing a location of each one of the devices, each location being defined in terms of network hierarchy, each location comprising a network identifier of the device in at least three levels of the network hierarchy. Finally, phase 530 comprises performing the device management action on each device in the set in an order selected based on the location such that consecutive ones of the devices in the order are separated at as high a level of the network hierarchy as possible.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in managing devices in a communication network.

### ACRONYMS LIST

ABC Definition
NEF network exposure function
PLMN public land mobile network
SCEF service capability exposure function

### REFERENCE SIGNS LIST

| | |
|---|---|
| 110 | device management server, DMS |
| 120 | NEF/SCEF |
| 130 | core network node |
| 140, 150 | base station |
| 146, 156 | radio link |
| 160 | devices |
| 201 | root |
| 212, 214 | PLMN identifiers |
| 222, 224, | area identifiers |
| 225 | |
| 232, 234, | base station identifiers |
| 236, 238 | |
| 242, 244, | cell identifiers |
| 246, 248, | |
| 249 | |
| 300-360 | structure of the device of FIG. 3 |
| 410-4115 | phases of the process of FIG. 4 |
| 510-530 | phases of the method of FIG. 5 |

1-21. (canceled)

22. An apparatus comprising at least one processing core, at least one memory including computer program code, the at least one memory and the computer program code being configured to, with the at least one processing core, cause the apparatus at least to:
define a set of devices for a device management action;
store a location of each one of the devices, each location being defined in terms of network hierarchy, each location comprising a network identifier of the device in at least three levels of the network hierarchy, and
perform the device management action on each device in the set in an order selected based on the location such that consecutive ones of the devices in the order are separated at as high a level of the network hierarchy as possible.

23. The apparatus according to claim 22, wherein the location comprises a public-network identifier in the highest level of network hierarchy, an area identifier as a second-highest level of network hierarchy, a base station identifier as a third-highest level of network hierarchy and a cell identity as a fourth-highest level of network hierarchy.

24. The apparatus according to claim 23, wherein the location comprises a sector identifier as a fifth-highest level of network hierarchy.

25. The apparatus according to claim 22, wherein the apparatus is configured to obtain the locations of the devices in the set from a network exposure function, NEF, or a service capability exposure function, SCEF.

26. The apparatus according to claim 22, wherein the device management action comprises one of: a firmware update, a configuration file update, an encryption key update or a parameter update.

27. The apparatus according to claim 22, wherein the network hierarchy is one of a fourth generation or fifth generation cellular communication network.

28. The apparatus according to claim 22, wherein the apparatus is configured to cause the device management action to be performed on at least two of the devices in the set simultaneously using broadcasting.

29. The apparatus according to claim 22, wherein the apparatus is configured to cause a broadcasted message to be sent in a part of the network hierarchy to inform at least two of the devices in the set that the device management action will be performed.

30. A method comprising:
defining, in an apparatus, a set of devices for a device management action;
storing a location of each one of the devices, each location being defined in terms of network hierarchy, each location comprising a network identifier of the device in at least three levels of the network hierarchy, and
performing the device management action on each device in the set in an order selected based on the location such that consecutive ones of the devices in the order are separated at as high a level of the network hierarchy as possible.

31. The method according to claim 30, wherein the location comprises a public-network identifier in the highest level of network hierarchy, an area identifier as a second-highest level of network hierarchy, a base station identifier as a third-highest level of network hierarchy and a cell identity as a fourth-highest level of network hierarchy.

32. The method according to claim 31, wherein the location comprises a sector identifier as a fifth-highest level of network hierarchy.

33. The method according to claim 30, further comprising obtaining the locations of the devices in the set from a network exposure function, NEF, or a service capability exposure function, SCEF.

34. The method according to claim 30, wherein the device management action comprises one of: a firmware update, a configuration file update, an encryption key update or a parameter update.

35. The method according to claim 30, wherein the network hierarchy is one of a fourth generation or fifth generation cellular communication network.

36. The method according to claim 30, further comprising causing the device management action to be performed on at least two of the devices in the set simultaneously using broadcasting.

37. The method according to claim 30, further comprising causing a broadcasted message to be sent in a part of the network hierarchy to inform at least two of the devices in the set that the device management action will be performed.

38. A system comprising an apparatus and an internet of things, IoT, device, wherein the IoT device is configured to transmit to the apparatus a request concerning whether the apparatus has a device management action pending for the IoT device, and responsive to the request the apparatus is configured to inform the IoT device concerning a device management action to be triggered for the IoT device, and wherein the apparatus comprising at least one processing core, at least one memory including computer program code, the at least one memory and the computer program code being configured to, with the at least one processing core, cause the apparatus at least to:
define a set of devices for a device management action;
store a location of each one of the devices, each location being defined in terms of network hierarchy, each location comprising a network identifier of the device in at least three levels of the network hierarchy, and
perform the device management action on each device in the set in an order selected based on the location such that consecutive ones of the devices in the order are separated at as high a level of the network hierarchy as possible.

39. The system according to claim 38, wherein the IoT device is configured to include in the request information concerning at least one of the following: a fault in a sensor comprised in the IoT device and an out-of-range result in an output of a sensor comprised in the IoT device.
